(19) United States
(12) Patent Application Publication
(10) Pub. No.: US 2017/0176343 A1
(43) Pub. Date: Jun. 22, 2017

(54) Method and System For Inspecting A Pipe

(71) Applicant: Venkat R. KRISHNAN, Houston, TX (US)

(72) Inventor: Venkat R. KRISHNAN, Houston, TX (US)

(21) Appl. No.: 15/337,722

(22) Filed: Oct. 28, 2016

Related U.S. Application Data
(60) Provisional application No. 62/268,542, filed on Dec. 17, 2015.

(51) Int. Cl. G01N 21/952; G01N 21/954; H04N 5/225; G01J 5/00

(52) U.S. Cl. CPC G01N 21/952; G01J 5/0003; G01N 21/954; H04N 5/225; G01J 2005/0077; H04N 2005/2255

(57) ABSTRACT

Methods and systems for identifying defects in pipes are provided. An example method for inspecting one or more metal structures in a pipe includes heating the pipe and placing an infrared (IR) sensor proximate to a surface of the pipe to obtain IR images of the pipe. Any defects are identified in at least one of the one or more metal structures in the IR images.

### CROSS-REFERENCE TO RELATED APPLICATION

This application claims the benefit of U.S. Provisional Patent Application 62/268,542, filed Dec. 17, 2015, entitled METHOD AND SYSTEM FOR INSPECTING A PIPE, the entirety of which is incorporated by reference herein.

### FIELD

The present techniques relate to non-destructive testing of pipes. More specifically, an infrared imaging system for identifying defects in metal structures in pipes is disclosed.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Since the 1970s, flexible pipes have been utilized in the hydrocarbon industry as flow lines, risers, and jumpers, among others, to transport raw materials, production fluids, and other materials associated with offshore oil and gas production. Overall, the enhanced flexibility and versatility of a flexible pipe lends to a more economical design solution for transporting offshore oil and gas. In particular, the flexible pipe has an advantage over rigid pipes due to its relatively low bending to axial stiffness, as opposed to a rigid pipe of the same diameter.

The structure of the flexible pipe typically includes a number of layers of different materials in the pipe wall fabrication. One such layer may include a metal layer, or an inner carcass, that is permeable to production fluids and is in direct contact with such fluids. The function of the inner carcass is to prevent the collapse of the flexible pipe as a result of gas expansion or hydrostatic pressure of sea water. Another layer of the flexible pipe may include a polymer sheath that can be used as an inner sheath layer and an outer sheath layer. The inner sheath layer may be implemented to maintain the integrity of the production fluids. Thus, the type of materials selected for the inner sheath layer may be based on various parameters such as the inner production fluid temperature, composition, and pressure. The outer sheath layer may be implemented to provide a barrier against factors external to the flexible pipe, including seawater diffusion and mechanical damage.

The flexible pipe may include an annular region located between the inner sheath layer and the outer sheath layer. The annular region may include armor wire layers that can include one or more pressure armor wire layers and tensile armor wire layers. Accordingly, pressure armor wire layers may be implemented to withstand internal pressures exerted by the inner production fluids. Tensile armor wire layers may be implemented to resist the tensile load on the flexible pipe. For example, the tensile armor wire layers may be utilized to support the weight of the flexible pipe as it extends from a side of a vessel and to transfer the load of the flexible pipe to the vessel and into a seabed.

Tensile armor wire layers constitute an important layer of an unbonded flexible pipe and serve to provide tensile reinforcement. They can be prone to damage or failure due to corrosion, fatigue, or a combination thereof. Therefore, flexible pipes should be inspected from time to time depending on the susceptibility of the armor wire layers to the aforesaid damage mechanisms.

Current inspection tools available in industry, such as inspection tools using magnetostriction principles (e.g., MAP™ Tools) and inspection tools using magnetic eddy current principles (e.g., MEC-FIT™ Tools),) which are focused on inspection of the tensile armor wire layers are expensive to deploy in an offshore environment. They are either limited in terms of applications or require extensive calibration and interpretation making them difficult to deploy.

Infrared sensing techniques have been used to inspect insulation of electrical lines. For example, U.S. Pat. No. 8,319,182 to Brady, et al. describes methods and systems for using Infrared (IR) spectroscopy to quantify degradation of insulation surrounding wiring. The system described includes an infrared (IR) spectrometer, and a fiber optic cable having a first end and a second end. The first end is configured to interface to the IR spectrometer and a clamping device mounts the second end of the fiber optic cable adjacent the wire insulation to be tested.

Another example is U.S. Pat. No. 6,995,565 to Brady, et al. which describes thermographic wiring inspection. The method described is directed to inspecting a wire, a cable, or a bundle of wires to locate those parts of said wires or cables having damaged insulation before failure of the wire or cable occurs. The method includes passing a current through the wire or cable, applying a fluid having electrolytic properties to the wire, cable, or bundle of wires, and using an infrared thermal imaging system to detect and display the intensity of heat emanating from the wire or cable following addition of the fluid.

Techniques for the effective inspection of defects in pipe, such as flexible pipe, often use complex techniques, such as eddy current detection, magnetic flux techniques, and other techniques that require complex interpretation to identify potential defects in the pipe. Further, these techniques may use large systems that can be difficult to implement in some environments. Thus, there remains an ongoing desire for more efficient techniques to identify defects in pipe due to degradation from cracking, corrosion, erosion, or combinations thereof, such as the degradation of armor wire layers within flexible pipes.

### SUMMARY

The present disclosure provides a method for inspecting one or more metal structures in a pipe. The method includes heating the pipe and placing an infrared (IR) sensor proximate to a surface of the pipe to obtain IR images of the pipe. Any defects are identified in at least one of the one or more metal structures in the IR images.

In another aspect, the present disclosure provides a system operable to inspect one or more metal structures in a pipe. The system includes an infrared (IR) sensor, an inspection device to which the IR sensor is mounted, and a data connection. The IR sensor is operable to obtain IR images at an infrared wavelength. The inspection device is operable to control a position of the IR sensor proximate to a surface of the pipe. The data connection is operable to transfer images from the IR sensor to an analysis system, wherein the analysis system is operable to identify defects in at least one of the one or more metal structures in the IR images.

In yet another aspect, the present disclosure provides a method for inspecting a flexible pipe. The method includes heating the flexible pipe and placing an infrared (IR) camera proximate to a surface of the flexible pipe to obtain IR images. Any defects in the flexible pipe are identified in the IR images.

### DESCRIPTION OF THE DRAWINGS

The advantages of the present techniques are better understood by referring to the following detailed description and the attached drawings, in which:

FIG. 1 is a cut-away drawing of a flexible pipe, showing cracks in metal structures that are hidden by other layers;

FIG. 2 is a cross-sectional view of a flexible pipe showing cracks that may form in various layers;

FIG. 3 is a drawing of a flexible pipe showing the outer sheath hiding any cracks 102 that may be present;

FIGS. 4A and 4B are depictions of an infrared (IR) image of a flexible pipe showing cracks in metal structures located underneath the sheath, such as the tensile armor wire layers;

FIG. 5 is a block diagram of an inspection system that can be used to perform IR inspections of pipes;

FIG. 6 is a drawing of an internal inspection device that can be used to perform IR inspections of pipes from the inside;

FIG. 7 is a drawing of an external inspection device that can be used to perform IR inspections of a pipe from the outside; and

FIG. 8 is a block diagram of a method for performing IR inspections of pipes.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

Eddy-current testing (ECT) is a nondestructive testing method that uses electromagnetic induction to detect flaws in conductive materials. An alternating electromagnetic field is imposed on the object under test, which creates currents in the conductive materials by inductance. These fields interact with the field imposed by the test apparatus. Flaws, such as cracks or breaks, in the material of the object change the currents, which can be detected by changes in the impedance amplitude and phase angle. An example of an eddy current detector for a flexible pipe is the MEC-HUG™ Crawler, available from Innospection Limited of Aberdeen, United Kingdom. A number of other suppliers provide equipment for ECT, including, for example, Rohmann of Frankenthal, Germany, and ETher NDE of St. Albans, United Kingdom. The eddy current testing may be used to heat the pipe for the infrared testing described herein, e.g., using the tester as an eddy current heater.

Infrared (IR) radiation is electromagnetic radiation of wavelengths in the range of from 0.7 micrometers (μm) to 15 μm. The frequency for imaging in the IR wavelength may range from 24 gigahertz (GHz) to 400,000 GHz. IR radiation is used to create images using IR sensors which are constructed and arranged to obtain IR images, such as thermographic cameras, for example, from IR radiation emitted by a warm surface, from IR radiation absorbed or reflected by a material, or combinations thereof. The IR radiation may be passive (from the environment) or active (illuminated by an IR source). An IR thermographic camera may come in three basic types, a near-IR wavelength, a mid-IR wavelength, and a long-IR wavelength. The near-IR wavelength IR cameras may obtain images at IR wavelengths between 0.9 μm and 1.7 μm. The mid-IR wavelength IR cameras may obtain images at IR wavelengths between 2 μm and 5 μm. The long-IR wavelength IR cameras may obtain images at IR wavelengths between 7 μm and 15 μm.

Long-IR wavelength IR cameras are used to obtain images from surfaces that are radiating or emitting their own heat. Any number of commercially available IR cameras may be used in the embodiments described herein, including IR cameras available from Fluke, a subsidiary of the Danaher Corporation of Washington, D.C., USA. Other IR cameras that may be used may be obtained from FLIR Systems of Wilsonville, Ore.

Magnetic flux leakage (MFL) is a magnetic method that may be used to detect corrosion and pitting in steel structures, such as pipelines and storage tanks. In MFL, a magnet is used to magnetize the steel. At areas where there is corrosion or missing metal, flux from the magnetic field “leaks” from the steel. A magnetic detector, placed between the poles of the magnet, may be used to detect the leakage field. The leakage field may be used to identify damaged areas and to estimate the depth of metal loss.

### Overview

There is an ongoing desire in industry to be able to detect defects in metal pipes in a straightforward, efficient manner. Early detection of defects in pipe improves system integrity and provides confidence in being able to timely detect defects which can allow pipe to remain in service longer than as designed. Further, pipes including a plurality of layers provide additional challenges for the detection of defects using existing inspection tools. The plurality of layers within the pipe may include one or more metal structure layers, for example a plurality of metal structure layers. The present techniques provide the ability to inspect such pipes and locate and identify defects in the metal structure layers in a straightforward, efficient manner.

One type of multi-layered pipe are flexible pipes which may be used in offshore production facilities to transport fluids of various pressure and temperature ranges while flexing during variable currents and wave actions. A flexible pipe includes a number of layers, such as an inner carcass layer, an inner sheath layer, one or more metallic armor wire layers, and an outer polymer sheath, among others. An annular region, containing the armor wire layers, may be located between the inner sheath layer and the outer sheath layer. Other types of multi-layered metal pipes are also intended to be within the scope of the present disclosure, such as corrosion resistant alloy (CRA) clad pipe, CRA lined pipe, coated pipe, polymeric clad pipe, polymeric lined pipe, double walled pipe such as pipe-in-pipe applications, insulated pipe, and the like. Although embodiments herein may refer to flexible pipes, it is understood that the described techniques can also be applied to such other types of multi-layered pipes.

Systems and methods described herein may be used to inspect flexible pipes for defects in the armor wire layers positioned between an outer sheath layer and an inner sheath layer. The defects may be located and identified by heating the flexible pipe, then obtaining an IR image of the surface. Variations in the image, indicating areas of temperature differentials, in particular cooler areas, may be used to identify defects, such as cracks, breaks, or other degradation in the wire of the armor wire layer. Cracks or breaks in the wire of the armor wire layer may be represented by intensity differences in the IR image such as darker or lighter regions. Similar to X-Ray imaging, the use of the IR based detection may require little or no data interpretation, unlike magnetic or eddy current based inspection methods which are currently used in industry. However, the IR imaging is simpler to implement, lowering costs and risks for the personnel involved, especially in an offshore environment. If the IR sensor and optionally a heater are deployed externally of the pipe, production operations may not even have to be stopped during inspection.

As described herein, the inspection may be performed using either internal or external inspection devices constructed and arranged to control the position of the IR sensor proximate to the surface of the pipe. For example, an ROV (remote operated vehicle), an AUV (autonomous underwater vehicle), or a pipe crawler may be deployed external to the flexible pipe to detect defects, such as breaks in outer tensile armor wire layers. As discussed herein, it may also be possible to inspect inner layers for defects, for example, by adjusting the focus on an infrared (IR) camera. The inspection device may also be deployed using a diver. In the case of external inspection in water environments, water seals may be employed around the inspection device to eliminate infrared absorbance from the water.

An inline inspection tool with infrared sensors, such as infrared cameras, thermographers, and the like, may be passed through the bore (interior space) of the pipe, for example, to inspect for defects in the innermost metal structure layers, such as an inner carcass layer in a flexible pipe.

Any number of defects or damage may be detected using the infrared imaging, including defects in metal pipes and flexible pipes. For example, in steel pipes, corroded pipe walls having a thinner cross-section may have a different thermal signature than non-corroded walls. Further, defects may be detected in coated pipes or pipe-in-pipe applications, both in the coatings and the underlying metal structures in the pipes. Weld defects in steel pipes, for example, under a CRA layer on the surface of the pipe, may be detected.

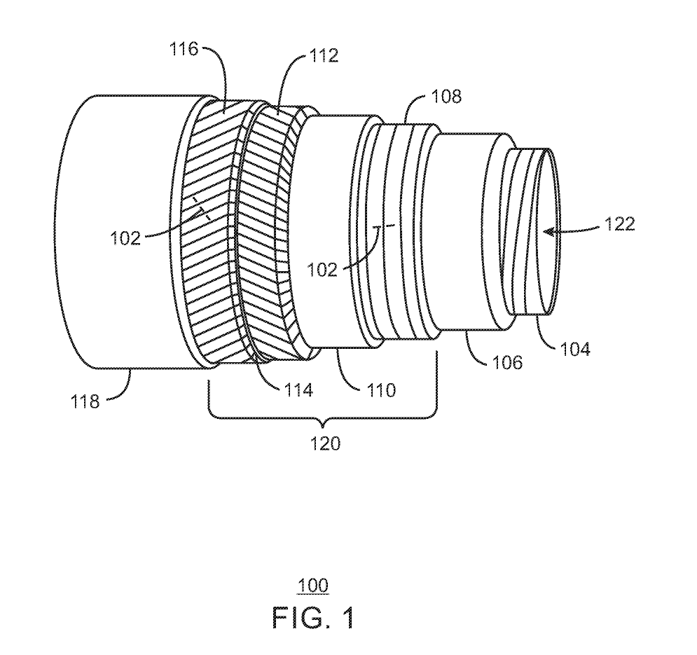

FIG. 1 is a cut-away drawing of a flexible pipe 100, showing cracks 102 in metal structures (108 and 116) that are hidden by other layers. Metal structures within the flexible pipe include pressure armor wire layer 108 and tensile armor wire layers 112 and 116. The flexible pipe 100 includes concentric layers of metals and polymeric materials, where each layer has a specific function. As shown in FIG. 1, the flexible pipe 100 includes the inner carcass layer 104, the inner sheath layer 106, a pressure armor wire layer 108, a plurality of tensile armor wire layers that may include first and second tensile armor wire layers 112 and 116, a first anti-wear tape layer 110, a second anti-wear tape layer 114, and an outer sheath layer 118. In this example, the pressure armor wire layer 108, the anti-wear tape layers 110 and 114 and the tensile armor wire layers 112 and 116 make up an annular region 120. The annular region 120 includes openings, for example, in the armor wire layers 108, 112, and 116 that may be infiltrated by production fluids, water, or both which penetrate the outer sheath layer 118 and/or the inner sheath layer 106.

The inner carcass layer 104 may form the innermost layer of the flexible pipe 100 and may prevent the collapse of the flexible pipe 100 due to pipe decompression, external pressures, mechanical crushing loads, or the build-up of gases in the annular region 120. The inner carcass layer 104 is a helically wound interlocking metal in the inner profile of the flexible pipe 100 that is not impermeable to the flow of the production fluids since it is not gas-tight or fluid-tight. As a result, the inner carcass layer 104 may be in direct contact with the production fluids, thus, the material of the inner carcass layer 104 may be made of a corrosion resistant material. By example, the inner carcass layer 104 may be made of stainless steel, where different grades of stainless steel may be utilized based on the characteristics of the production fluids or the environment of the flexible pipe 100. The described use of IR techniques to identify flaws in the hidden layers, e.g., the armor wire layers 108, 112, and 116, may also be used to identify cracks in the inner carcass layer 104 which may or may not lie on the inner surface of the carcass layer 104.

The inner sheath layer 106 may be extruded over the inner carcass layer 104, for example, using an extrusion process. The inner sheath layer 106 generally acts as a barrier to contain the production fluids flowing through the interior space 122 of the inner carcass layer 104. The inner sheath layer 106 may be a high-performance polymer that is resistance to mechanical and thermal stresses. Some materials utilized in the inner sheath layer 106 may include polyamides, cross-linked polyethylenes (XLPE), high-density polyethylenes (HDPE), polyvinylidene fluorides (PVDF), and other suitable polymeric materials. Environmental conditions may determine the selection of the material for the inner sheath layer 106. For example, for low temperature fluids, HDPE and polyamide may be used since these materials are suitable at about 65° C. (149° F.) and about 95° C. (203° F.), respectively. At higher temperatures, e.g., about 130° C. (266° F.), a more thermally stable material such as PVDF may be more suitable. While the inner surface of the inner carcass layer 104 may be accessible for identification of defects using an internal IR detection system, the inner sheath layer 106 may block metal structures external to (radially outside of) the inner sheath, such as pressure armor wire layer 108, from detection by IR imaging from the internal surfaces.

The pressure armor wire layer 108 may be wound around the inner sheath layer 106. The pressure armor wire layer 108 may be an interlocking metal spiral that allows bending of the flexible pipe 100. The material used for the interlocking metal spiral may include carbon steel with a yield strength in the range of about 700 megapascals (“MPa”) to about 1,400 MPa. In one or more embodiments, the pressure armor wire layer 108 may include C-shaped metallic wires, metallic strips of steel, or a combination of both. For example, the interlocking metal spirals of the pressure armor wire layer 108 may include various interlocking profiles including Zeta Flex-lok®, C-clip, or Theta shapes, among others.

The pressure armor wire layer 108 assists the flexible pipe 100 to withstand hoop stress from the internal pressure of the fluids transported by the flexible pipe 100. Further, the pressure armor wire layer 108 may increase the axial and burst strengths of the flexible pipe 100. In some applications, additional layers of non-interlocking flat steel profiles may cover the pressure armor wire layer 108 to provide added strength for high pressure applications. Cracks 102 and other damage to the pressure armor wire layer 108 may be detectable from the outside of the flexible pipe 100, however, layers external to the pressure armor wire layer 108 may inhibit the imaging by the IR sensor. Increased IR emissivity of intervening layers, such as an anti-wear tape 110, may make the damage visible in an IR image.

The tensile armor wire layers 112 and 116 may include several cross-wound layers of metal wires. The metal wires may be square, rectangular, round, or profiled in radial cross-section. For example, as shown in FIG. 1, a pair of tensile armor wire layers 112 and 116 may be cross-wound in opposite directions and separated by the second anti-wear tape layer 114. The cross-wound configuration may provide strength and reinforcement against axial stresses caused by internal pressures and external loads upon the flexible pipe 100, as well as tensile loads from the flexible pipe 100. The tensile armor wire layers 112 and 116 may be carbon steel, stainless steel, or other materials, depending on the application.

The tensile armor wire layers 112 and 116 may be at a lay angle of between about 20° to about 55°. The lay angle is the angle between an axis of the tensile armor wire layers 112 and 116 and a line parallel to a longitudinal axis of the flexible pipe 100. Winding the tensile armor wire layers 112 and 116 at these angles may help to support the weight of the flexible pipe 100 as it is off-loaded from a vessel and onto a seabed, transferring the weight of the flexible pipe 100 to the vessel.

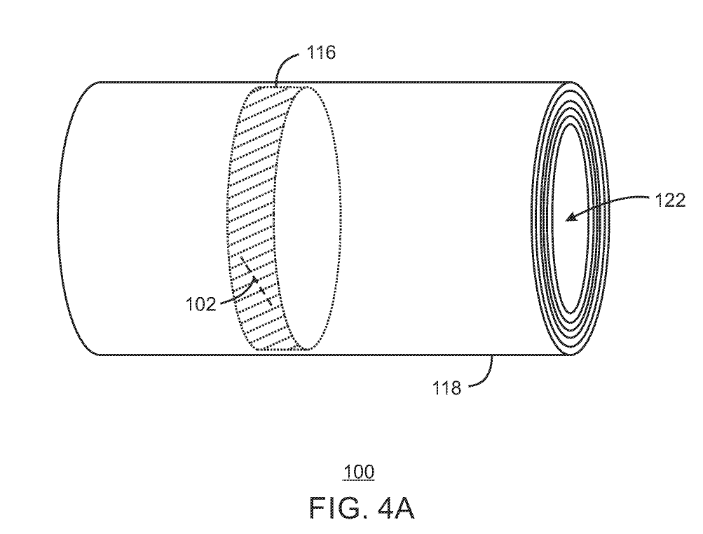

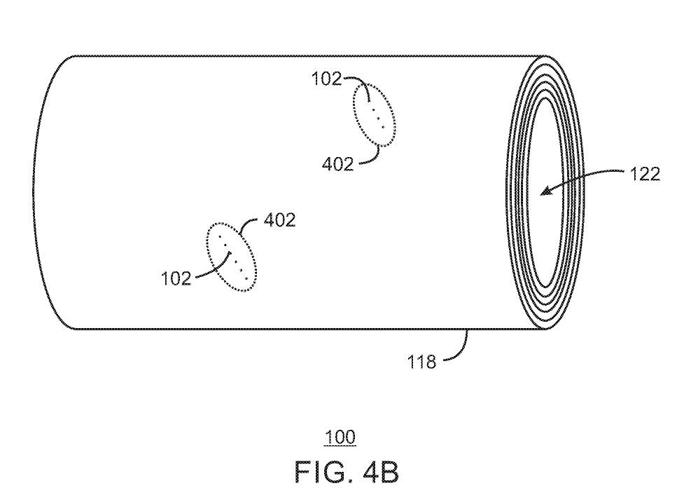

In one or more embodiments, the first anti-wear tape layer 110 may be wound around the pressure armor wire layer 108 and the second anti-wear tape layer 114 may be located between the first tensile armor wire layer 112 and the second tensile armor wire layer 116. Additionally, anti-wear tape layers may be located between any two metal structure layers to reduce friction and wear between the layers during movements of the flexible pipe 100. The anti-wear tape layers 110 and 114 may also aid the armor wire layers 108, 112, and 116 in maintaining their wound shape. The anti-wear tape layers 110 and 114 may be made of a thermoplastic material that is sufficiently durable to withstand contact stresses and slip amplitudes, e.g., high-density polyethylene (HDPE), polyamide 11 (a polyamide derived from vegetable oil such as castor oil), and polyvinylidene fluoride (PVDF), among other suitable polymeric materials. Such thermoplastic materials provide a wide range of favorable properties, such as flexibility and toughness, among others. Additionally, the anti-wear tape layers 110 and 114 may be wear resistant so as to retain their minimum strength at production temperatures and pressures. These materials may also have higher IR emissivity than other materials proximate to them, such as the layers of tensile armor wire layer 112 and 116, which may help to visualize damage in the pressure armor wire layer 108, for example, the polymeric layers may show colder regions over a defect, as discuss further with respect to FIG. 4B.

The flexible pipe 100 may include an outer sheath layer 118 that can be extruded over the second tensile armor wire layer 116. The outer sheath layer 118 may provide a seal against fluids external to the flexible pipe 100, such as seawater and fresh water, in order to prevent the infiltration of the external fluids into the annular region 120. Additionally, the flexible pipe 100 may be subjected to external forces that could affect the integrity of the armor wire layers 108, 112 and 116 and of the flexible pipe 100. Thus, the outer sheath layer 118 may provide mechanical protection against impact, erosion, and tearing, among other external factors. The outer sheath layer 118 may be composed of a durable polymeric material as detailed with respect to the inner sheath layer 106. The inner sheath layer 106 and the outer sheath layer 118 may be made from the same or different materials. Further, each of the sheath layers 106 and 118 may include material blends, alloys, compounds, or sub-layers of composite materials, among others.

Damage to the flexible pipe 100 may cause failure of the metal structures in the flexible pipe 100, including for example, the pressure armor wire layer 108, the tensile armor wire layers 112 and 116, and the inner carcass layer 104. For example, bending over a tight radius may overstress the metal structures, leading to the formation of defects, such as cracks 102 or breaks, in the pressure armor wire layer 108, the tensile armor wire layers 112 and 116, and the inner carcass layer 104. As another example, failure of the inner sheath layer 106 may lead to the flooding of the annular region 120 with corrosive production fluids. Exposure to such corrosive production fluids may lead to defects, such as corrosion or other degradation, of the pressure armor wire layer 108, or the tensile armor wire layers 112 and 116. For example, carbon dioxide (CO₂) and hydrogen sulfide (H₂S) may diffuse through the inner sheath layer 106 into the annular region 120 to form a corrosive environment.

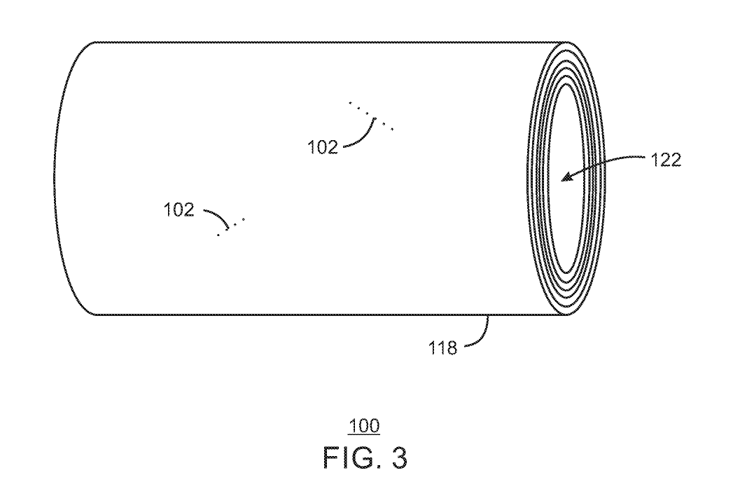

As the metal structures are hidden by the outer sheath layer 118 or the inner sheath layer 106, cracks 102 or other damage may not be easily detected using current inspection tools. Accordingly, techniques described herein may be used to detect and identify damage through other layers. This may be performed by heating a flexible pipe 100, and then imaging the flexible pipe 100 at an infrared wavelength of electromagnetic radiation, as discussed further with respect to FIGS. 3 and 4. Further, the inspection may be performed from the exterior surface of the flexible pipe 100, or by passing an inspection device through the bore or interior space 122 of the pipe.

The drawing of FIG. 1 is not intended to indicate that the flexible pipe 100 is to include all of the components shown in FIG. 1. Further, any number of additional components may be included within the flexible pipe 100, depending on the details of the specific implementation. For example, the flexible pipe 100 may include any suitable number of sheath layers, anti-wear tape layers, or armor wire layers, in various configurations. The metal structures may be selected from a pressure armor wire layer, a tensile armor wire layer, and combinations thereof. Further, the IR imaging may be used to identify internal corrosion damage within the flexible pipe 100. The corrosion may be from microbial or other corrosion which can result in induced wall loss under a polymeric sheath. For example, the presence of corrosion in a layer may make that layer thinner, leading to different emissivity for that layer. In one or more embodiments, the IR inspection techniques described herein may be used to find defects in non-flexible pipe, such as steel pipe used for pipelines. This may be performed on coated or uncoated pipe surfaces, clad or unclad pipe surfaces, lined or unlined pipe surfaces, and the like. The IR inspection techniques may be utilized to detect a lack of fusion in bi-metallic welds in clad or lined CRA pipe or to detect microbial or other corrosion induced wall loss in coated pipe.

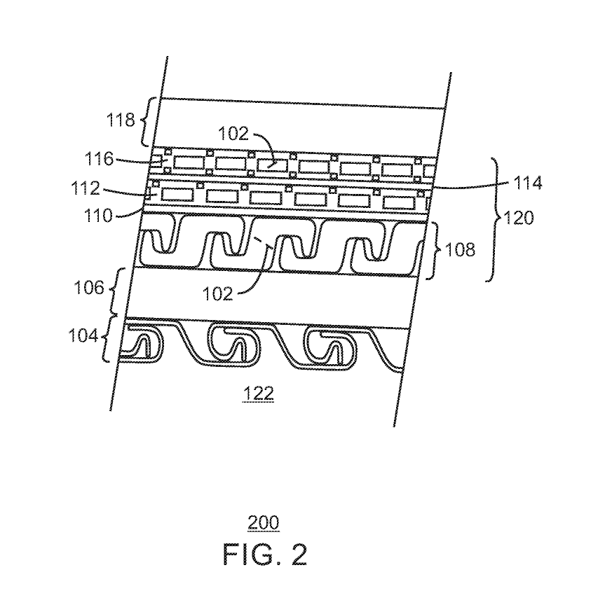

FIG. 2 is a cross-sectional view of a flexible pipe 200 showing cracks 102 that may form in various layers. Like numbers are as described with respect to FIG. 1. As shown in FIG. 2, the flexible pipe 200 may include the inner carcass layer 104, the inner sheath layer 106, a pressure armor wire layer 108, a first anti-wear tape layer 110, a first tensile armor wire layer 112, a second anti-wear tape layer 114, a second tensile wire 116, and an outer sheath layer 118. The pressure armor wire layer 108, the anti-wear tape layers 110 and 114 and the tensile armor wire layers 112 and 116 may collectively make up an annular region 120.

As described with respect to FIG. 1, bending of the flexible pipe 200 around a narrow radius or attack by corrosive compounds may lead to damage, such as the cracks 102, which do not lie on either the interior or the exterior surface of the flexible pipe 200. Heating the flexible pipe 200 can cause the interior metal structures to radiate in the IR wavelengths, which may be imaged by an IR sensor. The imaging can be used to identify cracks 102 and other defects.

FIG. 3 is a drawing of a flexible pipe 100 showing the outer sheath 118 covering or concealing any cracks 102 that may be present. Like numbered items are as described with respect to FIG. 1. From the outside of the flexible pipe 100, damage to internal metal structures, such as cracks 102, are hidden from view. Accordingly, the damage may lead to problems such as flexible pipe failure before it is identified. An IR image can take advantage of heat radiating from internal metal structures to identify internal damage. Internal metal structures are those metal structures that are separated from the IR sensor by at least one layer of material in the pipe. Further, the resolution of the IR image can identify damage with more specificity than other techniques, such as eddy current inspection. In one or more embodiments, the IR inspection may be used as a complementary tool to other inspection techniques, such as eddy current inspection or magnetic flux leakage.

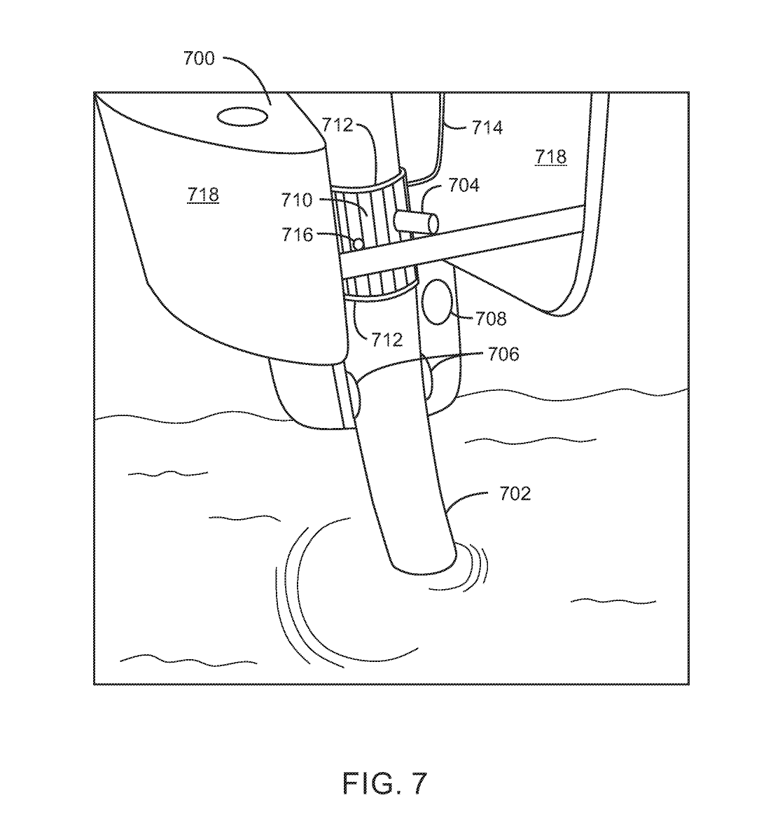

As described herein, absorption of the IR radiation by water may make external underwater detection difficult. Accordingly, water may be excluded from the detection area, for example, by surrounding the IR camera, or sensor, with a seal such as a rubber sheath. Water may then be replaced with air inside the seal. This is described further with respect to FIG. 7.

FIG. 4A is a representation of a potential infrared (IR) image of a flexible pipe 100 showing cracks 102 in a metal structure located underneath the sheath, such as the tensile armor wire layer 116 under the outer sheath layer 118. Like numbered items are as described with respect to FIG. 1. In this view, the flexible pipe 100 has been heated so that the metal structure radiates in the IR wavelengths, for example, by passing current through the metal structures, among other techniques. Described are two ways that may be used to detect the cracks 102 or other defects in the metal structures. First, the IR electromagnetic radiation emitted by the metal structure, such as at wavelengths between 0.7 μm and 12 μm, can pass through the external outer sheath layer 118 of the flexible pipe 100 and be imaged by the IR sensor. Identifying the location of defects in the different layers, such as tensile armor wire layer 116, may be achieved by changing or adjusting the focus of the IR sensor. As shown in FIG. 4A, internal structure, such as the tensile armor wire layer 116 under the outer sheath layer 118, is visible in the IR wavelength.

However, as shown in FIG. 4B, if the IR electromagnetic radiation from the internal armor wire layer does not pass through the external outer sheath layer, the differential surface temperature of the external outer sheath can provide an indication of defects in the tensile armor wire layer 116 underneath the outer sheath layer 118. The area 402 of the outer sheath layer 118 with the underlying damaged wires may be at a different, temperature than the undamaged portion, for example, cooler. This may be indicated by the area 402 showing as a different intensity in the IR image, such as darker than the surrounding regions of the sheath 118. In FIG. 4B, the cracks 102 are shown as dotted lines for reference, but may not be visible in the IR image. For example, the outer sheath layer 118 may be made from a polymer that has a higher IR emissivity than the metal structures. Accordingly, the outer sheath layer 118 may be indicative of the wire temperature in the tensile armor wire layer. Thus, while the metal wire will indicate background temperature, e.g., IR electromagnetic radiation emitted from the metal surface, the outer sheath layer 118 may appear hotter than the tensile armor wire layer 116, which may obscure the tensile armor wire layer 116 in the IR image. However, in the area of a wire break, crack 102, or other defect, the absence of metal may cause the outer sheath layer 118 to be cooler. As the IR sensors may detect temperature differences as low as 0.02 Kelvin, the cracks or breaks underneath the outer sheath layer 118 may be visible in IR wavelengths. The temperature differential of a non-metallic layer positioned between the metal structure and the IR sensor, such as a sheath layer, a corrosion protection layer, insulation layer, and the like, may be used to identify defects in the underlying metal structures. Metal structures may include one or more of a base pipe, armor wire layers, and the like. Base pipe may be a base metallic layer which is coated, clad, lined, insulated, and combinations thereof to form the pipe.

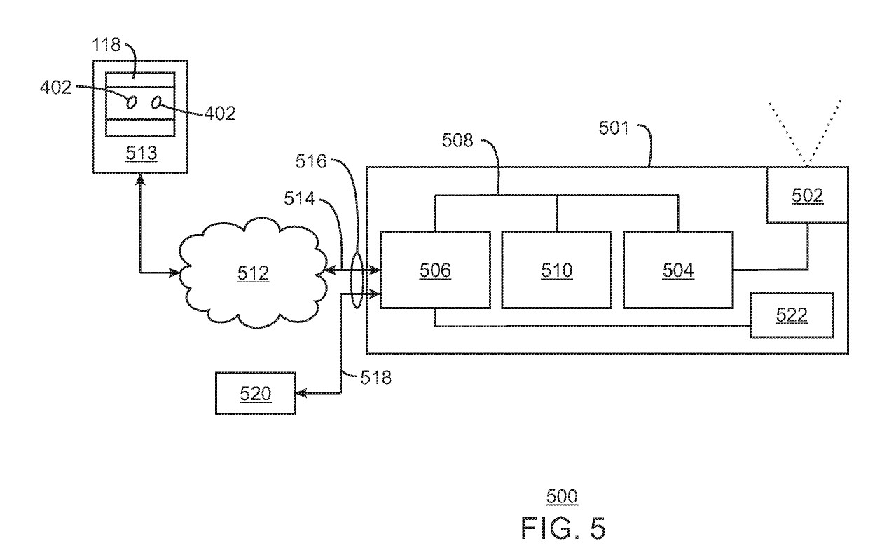

FIG. 5 is a block diagram of an inspection system 500 that can be used to perform IR inspections of pipes. The inspection system includes an inspection device 501. The inspection device 501 may include any number of commercially available units that may be modified to be equipped with the IR sensors described herein. For example, an external inspection device that may be used is the MEC-Hug Crawler, available from Innospection Limited of Aberdeen, United Kingdom. An inspection device that may be used for internal inspections is the ROVVER X robotic inspection camera available from Environsight LLC of Randolph, N.J., USA.

For inspection devices 501 that may be used for internal or external inspections, the basic units may be the same. For example, either type of inspection device 501 may be equipped with an IR sensor 502, such as an IR camera. An imaging interface 504 passes the image from the IR sensor 502 to an interface or control system 506, such as a microcontroller with an Ethernet and power interface, over an internal bus 508. In one or more embodiments, the imaging interface 504 may be a high speed serial bus, for example, compliant with the USB 2.0 , USB 3.0, or PCIe standards. In other cases, the imaging interface 504 may be an image interface designed to provide high speed video from an IR camera, such as an interface compatible with the GigE™ camera interface standard maintained by the Automated Imaging Association. In other embodiments, the image signal, such as a video stream, may be directly transferred from the IR sensor 502 to an analysis system 513 without passing through the control system 506 and the imaging interface 504.

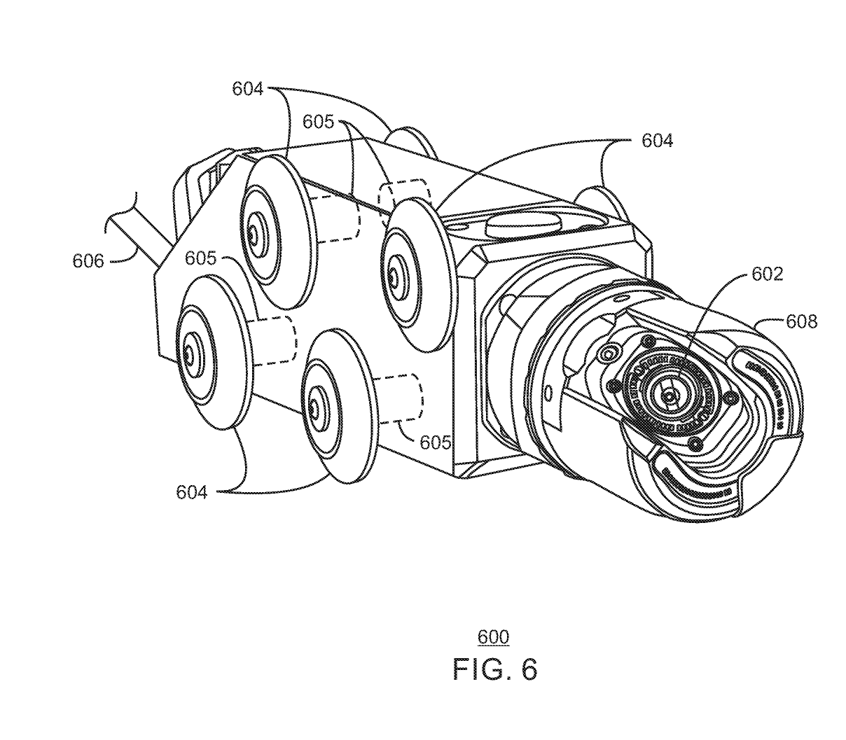

The control system 506 may be coupled to a propulsion system 510 that may move the inspection device 501 along the outside of a flexible pipe, or through the bore or interior space of the pipe, as described with respect to FIGS. 6 and 7. The propulsion system 510 may include motors driving wheels or tracks, among others. In one or more embodiments, the propulsion system 510 may be external to the inspection device 501, such as a crane or winch to pull the inspection device 501 through a pipe, or over the outside of a pipe.

Any number of microprocessor based systems may be used as the control system 506. Such systems may include small single board controllers, such as the Raspberry PI system available from the Raspberry PI Foundation, or any number of microcontroller systems. Such microcontroller systems may be available from Cypress Semiconductor of San Jose, Calif., USA, Freescale Semiconductor (formerly Motorola) of Austin, Tex., USA, Intel Corporation of Santa Clara, Calif., USA, or Texas Instruments of Dallas, Tex., USA, among many others. In one or more embodiments, the control system 506 may function only as a network router, for example, to direct control and image signals from the control system 506, for example, to and from the propulsion system 510 and IR sensor 502.

A cloud computing network 512 may provide communications with an analysis system 513, for example, through a data connection 514 in a tether 516 connected to the inspection device 501. The data connection 514 is used to transfer IR images, such as an IR video stream to the analysis system 513. The analysis system 513 may be used to control the inspection device 501, for example, by causing the inspection device 501 to move over or in the pipe, to direct the IR sensor 502 to specific areas, and the like. The analysis system 513 obtains IR images from the inspection device 501. The analysis system 513 may be constructed and arranged to then display the IR images, for example, of a region of an outer sheath 118 of the pipe, showing areas 402 having different intensities, and thus, temperatures, which can indicate defects under the sheath. The analysis system may be automated to autonomously identify defects in the one or more metal structures in the IR images.

The tether 516 may also include power lines 518 that couple the inspection device 501 to an external power source 520. In one or more other embodiments, the power source 520 may be included in the inspection device 501. In these embodiments, communications may be through a wireless data connection such as a wireless local area network (WLAN) provided by radio transceiver 522, for example, compliant with the IEEE 802.11a/b/g/n/ac standards. Other communications systems, for example, based on optical or acoustic communications devices, may also be used as the data connection.

FIG. 6 is a drawing of an internal inspection device 600 that can be used to perform IR inspections of pipes from the inside. As described herein, the internal inspection device 600 may be a commercially available inspection device that has been retrofitted with an IR sensor 602, for example, a ROVVER X from Environsight Corporation may be equipped with an IR sensor . The internal inspection device 600 may have wheels 604 powered by motors 605 (shown in dashed lines) to propel the internal inspection device 600 through the interior of the pipe. The wheels 604 may be located proximate the top and the bottom of both sides to stabilize the internal inspection device 600 in vertical lines. In some examples, the wheels 604 may be located only proximate the bottom of both sides, for example, if the internal inspection device 600 is to be used to inspect a horizontal pipe. A tether 606 may be used to provide a power connection and a data connection for communication with the internal inspection device 600. The IR sensor 602 may be mounted in a head 608 that rotates to allow IR images to be formed around a complete radius of the flexible pipe.

FIG. 7 is a drawing of an external inspection device 700 that can be used to perform external IR inspections of a pipe 702. The external inspection device 700 may be a remote operated vehicle (ROV), an autonomous underwater vehicle (AUV), or, as shown in FIG. 7, a pipe crawler. In some examples, the external inspection device 700, can be manually deployed, for example, by a diver. The external inspection device 700 may include an IR sensor 704 as described herein. Wheels 706, or other propulsion systems, may be used to move the external inspection device 700 axially along a length of the pipe 702. In addition to the IR sensor 704, other nondestructive inspection sensors 708 may be used. These may include, for example, magnetic inspection systems such as ECTs, MFLs, and the like.

The IR sensor 704 may be mounted on a sheath 710 surrounding the pipe 702. Rubber seals 712 at each end of the sheath may be used to exclude water from the surface of the pipe 702, for example, by pumping in air through an air line 714. The sheath 710 may be coupled to a motor 716 to allow the IR sensor 704 to circumferentially rotate about the outside of the pipe 702.

The pipe 702 may be heated by any number of techniques. For example, an eddy current unit 718, used as part of an ECT or MFL test device, may be used to heat the pipe 702. Further, a hot fluid, such as a production fluid, may be passed through the pipe 702.

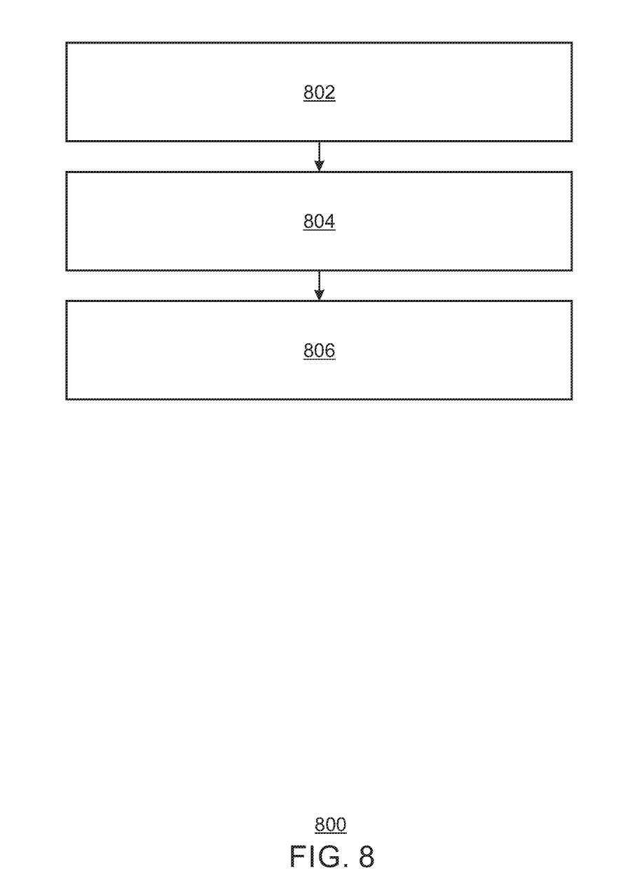

FIG. 8 is a block diagram of a method 800 for performing IR inspections of pipes. The method 800 begins at block 802 with heating the pipe. This may be done using any number of methods. For example, the metal structures in the pipe may be heated by an active CP (cathodic protection) current using rectifiers that are coupled to internal metal structures, such as armor wire layers, to pass a current through the internal metal structures. Another technique may be the use of eddy current heating to heat a local cross-section of the pipe for inspection. This may be performed in conjunction with other inspection techniques, such as ECT. A hot fluid may be passed through the pipe to heat the pipe. Furthermore, if the fluid being produced or injected through the bore or interior space of the pipe is of a sufficient temperature to heat up the entire cross-section including, for example, armor wire layers in a flexible pipe, no additional heating may be necessary.

At block 804, an infrared (IR) sensor, such as a camera, may be placed proximate to a surface of the pipe to obtain IR images. The IR sensor may be passed along an axial length of the pipe. Such may occur along the exterior of the pipe or through the bore or interior space of the pipe. The IR sensor may radially rotate to obtain images of the radial surface (circumference) of the pipe at an axial location along the length of the pipe. The inspection may be performed in the field or in other locations. For example, a flexible pipe may be inspected during manufacturing at an inspection station after the addition of each layer of the flexible pipe. This may also allow for rapid identification of weak or thin spots in extruded polymer sheath layers after the polymer extrusion process, for internal and external sheath layers, such as while the polymer is still cooling down during the curing process. The inner carcass layer of a flexible pipe may also be inspected by using the camera as an inline or external IR inspection tool. The bare carcass will not have outer layers covering it after construction, making this suitable for external inspection immediately after the manufacturing. An inline inspection technique may be used to check for damage prior to installation offshore.

At block 806, defects are identified in a metal structure in the IR images. As described herein, this may be done by identifying areas in the images representative of a lesser temperature than the surrounding area which can be indicative of a lack of contiguous metal or other material. The temperature differences may indicate defects such as cracks or breaks in the armor wire layers or other metal structures.

Further, any number of other issues may be identified using the current techniques. For example, the techniques may be used to inspect a flexible pipe for a flooded annulus, based on a difference between an IR image of an unflooded section and an IR image of a flooded section. The techniques may also be used to detect defects in armored umbilicals, e.g., armor wire layers, in a similar fashion to inspecting a flexible pipe.

The techniques are not limited to flexible pipes, and may be used for inspections of other pipes and systems. For example, the IR techniques may be used to detect defects in steel pipes. In this example, the thermal signature of corroded pipe walls that are thinner in cross-section may be different from that of non-corroded walls. Cracks, breaks, or poor welds may also be identified in the IR images. The techniques may be used to detect defects in other layered pipes such as coated pipes or pipe-in-pipe applications, both in the coatings and the underlying steel pipes. In addition to examining exposed welds, the techniques may be used to detect weld defects in steel pipes that have a CRA lining or cladding. Further, the techniques may be used to identify corroded or defective mooring chains used to tether offshore vessels, such as floating production, storage, and offloading platforms (FPSOs), and floating storage and offloading platforms (FSOs).

While the present techniques may be susceptible to various modifications and alternative forms, the examples discussed above have been shown only by way of example. However, it should again be understood that the present techniques are not intended to be limited to the particular examples disclosed herein. Indeed, the present techniques include all alternatives, modifications, and equivalents falling within the true spirit and scope of the appended claims.

What is claimed is:

1. A method for inspecting one or more metal structures in a pipe, comprising:
heating the pipe;
placing an infrared (IR) sensor proximate to a surface of the pipe to obtain IR images of the pipe; and
identifying any defects in at least one of the one or more metal structures in the IR images.

2. The method of claim 1, further comprising passing the IR sensor along an axial length of an exterior surface of the pipe.

3. The method of claim 1, further comprising passing the IR sensor along an axial length through an interior space of the pipe.

4. The method of claim 1, wherein heating of the pipe includes passing a hot fluid through the pipe.

5. The method of claim 1, wherein the heating of the pipe includes passing a current through at least one of the one or more metal structures.

6. The method of claim 1, further comprising adjusting a focus of the IR sensor to obtain IR images of a plurality of metal structures in the pipe.

7. The method of claim 1, wherein identifying defects includes identifying areas having a different intensity in the IR images.

8. The method of claim 1, further comprising passing the IR sensor around a circumference of the pipe at an axial location along the length of the pipe.

9. The method of claim 1, wherein the one or more metal structures are selected from a pressure armor wire layer, a tensile armor wire layer, and combinations thereof.

10. A system for inspecting one or more metal structures in a pipe, comprising:
an infrared (IR) sensor operable to obtain IR images at an infrared wavelength;
an inspection device to which the IR sensor is mounted, wherein the inspection device is operable to control a position of the IR sensor proximate to a surface of the pipe; and
a data connection operable to transfer images from the IR sensor to an analysis system, wherein the analysis system is operable to identify defects in at least one of the one or more metal structures in the IR images.

11. The system of claim 10, comprising a seal to keep water from coming in between the IR sensor and the surface of the pipe during external inspection.

12. The system of claim 10, wherein the IR sensor comprises an IR camera.

13. The system of claim 10, wherein the IR sensor sends an IR video stream to the analysis system via the data connection.

14. The system of claim 10, wherein the inspection device comprises a tether to provide a coupling for power, the data connection, or both.

15. The system of claim 10, wherein the inspection device comprises a radio transceiver to provide the data connection and communicate with the analysis system.

16. The system of claim 10, wherein the inspection device comprises an eddy current heater to heat at least one of the one or more metal structures.

17. The system of claim 10, wherein the inspection device is operable to move through an interior space in the pipe.

18. The system of claim 17, wherein the inspection device comprises a propulsion system to move the inspection device through the interior space.

19. The system of claim 10, wherein the inspection device comprises a propulsion system to move over an exterior surface.

20. The system of claim 10, wherein the inspection device comprises an additional nondestructive inspection sensor.

21. A method for inspecting a flexible pipe, comprising:
heating the flexible pipe;
placing an infrared (IR) camera proximate to a surface of the flexible pipe to obtain IR images; and
identifying any defects in the flexible pipe in the IR images.
